(19) United States
(12) Patent Application Publication
(10) Pub. No.: US 2004/0164011 A1
(43) Pub. Date: Aug. 26, 2004

(54) Marine aquarium filter

(76) Inventor: James Michael Geudtner, Hermosa, CA (US)

Correspondence Address: JIM GEUDTNER, 1130 1/2 15th Street, HERMOSA BEACH, CA, 90254, US

(21) Appl. No.: 10/371,571

(22) Filed: Feb. 24, 2003

(51) Int. Cl. A01K 63/04

(52) U.S. Cl. 210/169; 119/259

(57) ABSTRACT

An aquarium filter which incorporates a protein skimmer with a plurality of plenum trays stacked in the main filter chamber. The unit is placed on the inside back wall of the aquarium. A venturi pump injects an air and water mixture into the skimmer chamber. The foam generated floats to the top of the skimmer where it is removed by a low profile skimmer spout. The water flows down to the bottom of the skimmer and into the plenum chamber where it flows around the self contained plenum trays. A plenum tray consists of a five sided rectangular box that is open at the top. A sand screen creates a low oxygen water plenum at the bottom of the tray. This plenum is overlaid by several inches of sand. At the opposite end from the skimmer is a particulate filter grate through which the water is returned to the aquarium.

### BACKGROUND OF THE INVENTION

This invention pertains to the marine aquarium hobby. Specifically, the attempt to duplicate as closely as possible, a marine environment in a closed aquarium system.

Marine aquarium filtration systems are purchased as distinct units or made by hand by the hobbyist. Many hobbyists use a large external sump to house their filter components and large electric pump(s) are used to transfer water between the aquarium and the sump. In addition, mineral supplements are often required to maintain trace elements and dissolved calcium needed for coral growth.

The under gravel plenum is a biological filtration device that is accepted as an efficient way to reduce the nitrate levels and increase beneficial mineral ions needed by hard corals. The accepted installation of this filter in the bottom of the tank, however, makes it vulnerable to disruption by the captive animals and subject to “dead spots” caused by overlaying live rock. In addition, Detritus generated by the captive animals tends to build up in the plenum and is very difficult to remove.

Protein skimming is also an accepted method for pollutant removal but skimmers can be obtrusive and noisy.

### SUMMARY OF THE INVENTION

The marine filter system incorporates an under gravel plenum with a protein skimmer and particulate filter into a single, modular, quiet, compact unit that hangs on the inside back wall of the aquarium. The entire system is driven by a small venturi water pump. A stream of water and fine air bubbles is pumped from the aquarium, into the protein skimmer chamber. A foam is produced and directed through a low profile spout at the top of the skimmer to a collection cup. The water flow continues out from the bottom of the skimmer chamber into the plenum chamber. The plenum chamber houses several plenum trays stacked vertically. The water flows gently around the trays, maintaining the biological environment of the plenums without disturbing the substrate in the trays. At the opposite end from the skimmer is a particulate filter grate through which water is returned to the aquarium.

It is the object of the present invention to provide a filter system that reduces nitrate levels and provides dissolved mineral ions for improved hard coral growth in marine aquaria.

It is yet another object of the present invention to provide a filter system that removes particulate and surfactant pollutants from marine aquaria.

It is yet another object of the present invention to provide a plurality of modular plenums that are protected from disruption by aquarium animals, and are immune to dead spots,

It is yet another object of the present invention to provide a plurality of modular plenums that can be removed intact from the filter unit and propagated to another aquarium.

It is yet another object of the present invention to reduce the amount of coral sand required to maintain a healthy marine aquarium.

It is yet another object of the present invention to provide a protein skimmer spout that is efficient and low profile.

It is yet another object of the present invention to provide a large area particulate filter that is easy to maintain.

It is yet another object of the present invention to provide a filter system that is unobtrusive, quiet and has low energy requirements.

### BRIEF DESCRIPTION OF THE SEVERAL VIEWS OF THE DRAWING

FIG. 1 is a front sectional view, end views, and top view.

FIG. 2 is a front sectional view with the venturi pump, protein skimmer spout and collection cup.

### DETAILED DESCRIPTION OF THE INVENTION

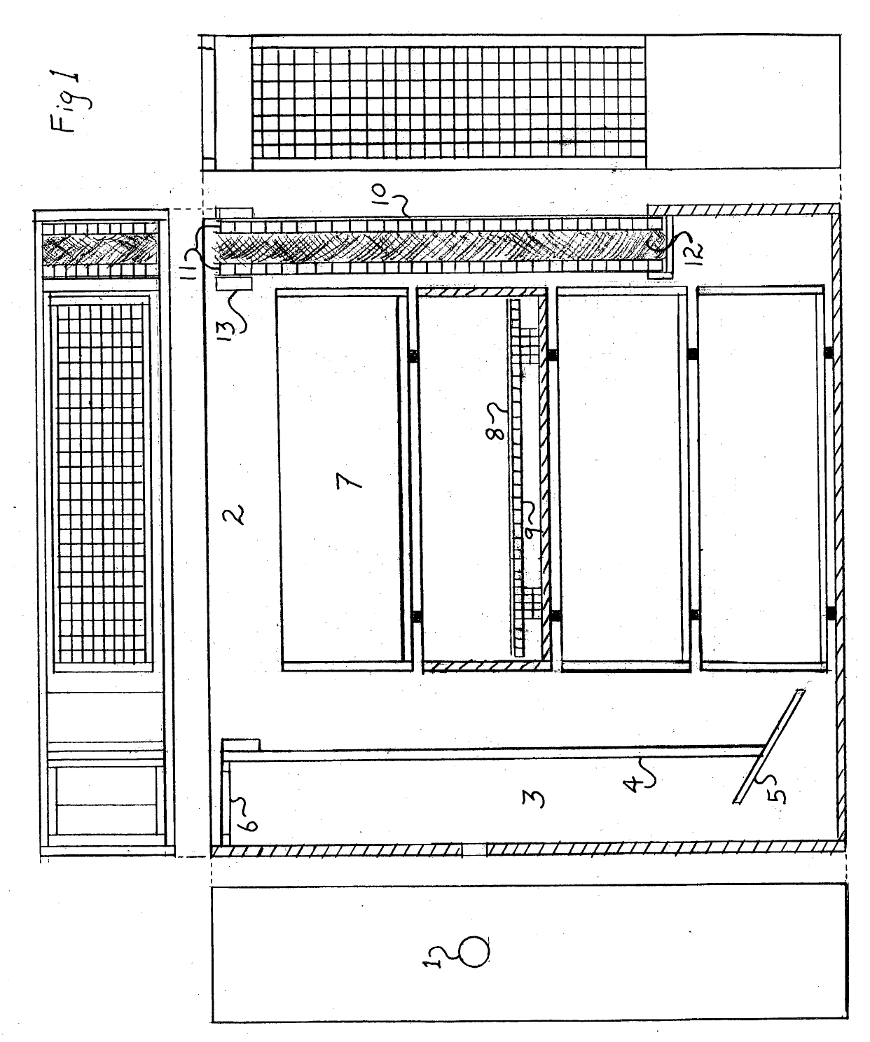

Referring to FIG. 1, the marine aquarium filter device comprises a main compartment 2, which houses the protein skimmer 3, the plenum trays 7, the particulate filter 10, and support struts 13. The skimmer chamber 3, comprises a pump input port 1, a bulkhead 4, a baffle 5, and a foam outlet 6. The plenum trays 7, contain the plenum support grate 9, and the sand screen 8. The particulate filter 10, comprises filter media 12, sandwiched between 2 filter grates 11.

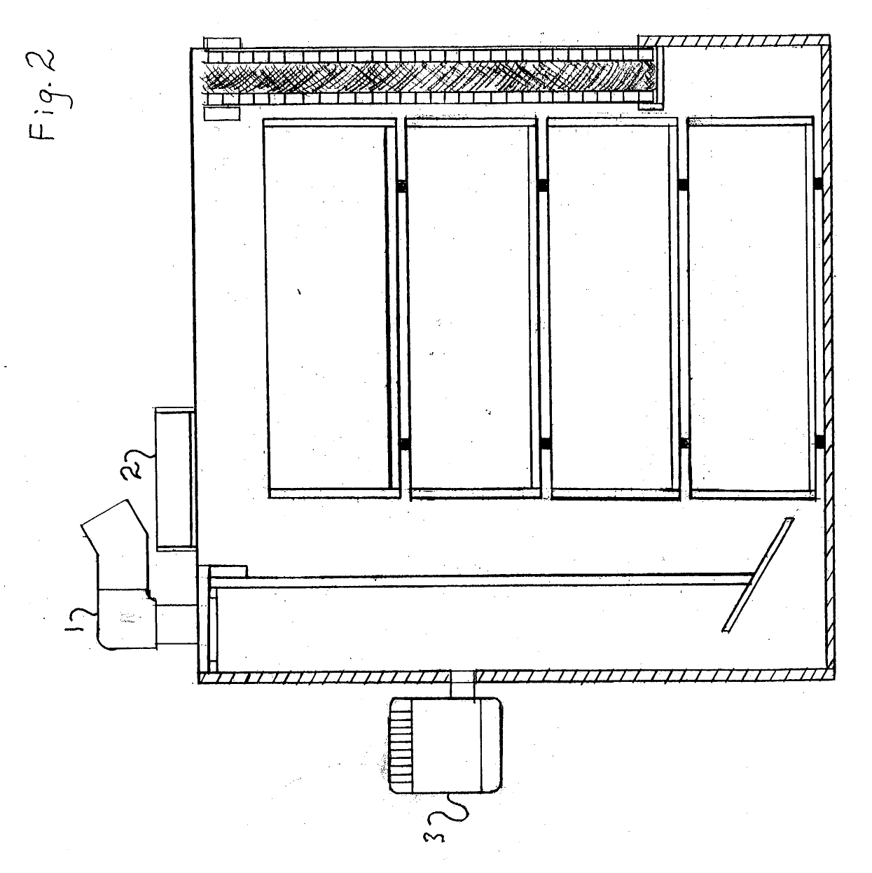

Referring to FIG. 2, the protein skimmer spout 1, collection cup 2, and the venturi pump 3.

### Installation Procedure

The main compartment, plenum trays, and skimmer collection cup are made of acrylic sheet using standard fabrication methods. The protein skimmer spout FIG. 2-1, may be made of standard PVC pipe or similar. The plenum grate FIG. 1-9, and the particulate filter grates FIG. 1-11, are made of standard fluorescent light diffusing grate or similar. The filter floss FIG. 1-12, is polyester filter floss.

1. Add sea water to each of the plenum trays assuring that no air is trapped in the plenum screen.

2. Add new, fine grain, rinsed, aragonite sand to each of the plenum trays to a depth of about 2 inches.

3. Place the main compartment in the aquarium and stack the plenum trays in the plenum chamber next to the protein skimmer.

4. Place the filter against the back wall of the aquarium.

5. Slide the protein skimmer spout onto the skimmer seat.

6. Secure the filter to the aquarium top using the suspension clips.

7. Install the venturi pump to the skimmer intake port

8. Place the protein skimmer collection cup beneath the skimmer spout.

While the invention has been described in complete detail and shown in the drawings, it is not to be limited to such details, since many changes and modifications may be in the invention without departing from the spirit and scope thereof. The invention is described to cover any and all modifications and forms which may come within the language and scope of the appended claims.

I claim:

1. A marine aquarium filter device comprises:
A main compartment housing a protein skimmer chamber, baffle plate, plenum trays, and particulate filter.

2. A marine aquarium filter device comprises:
A low profile protein skimmer spout and collection cup.

3. A marine aquarium filter device comprises:
Modular plenum trays comprised of a 5 sided compartment which contains a plenum grate, and a sand screen.
